(19) United States
(12) Patent Application Publication
(10) Pub. No.: US 2013/0342683 A1
(43) Pub. Date: Dec. 26, 2013

(54) System and Method for Detecting Environmental Conditions Using Hyperspectral Imaging

(71) Applicant: ChemImage Corporation, Pittsburgh, PA (US)

(72) Inventors: Matthew Nelson, Harrison City, PA (US); Jeffrey Cohen, Pittsburgh, PA (US); Oksana Klueve, Pittsburgh, PA (US); Patrick Treado, Pittsburgh, PA (US); Charles Gardner, Gibsonia, PA (US)

(21) Appl. No.: 13/973,769

(22) Filed: Aug. 22, 2013

Related U.S. Application Data
(63) Continuation-in-part of application No. 12/924,831, filed on Oct. 6, 2010.
(60) Provisional application No. 61/691,861, filed on Aug. 22, 2012.

(51) Int. Cl. G01W 1/00

(52) U.S. Cl. CPC G01W 1/00
USPC 348/135

(57) ABSTRACT

A system and method for detecting environmental conditions using SWIR hyperspectral imaging. A method may comprise collecting a plurality of interacted photons from at least one location and passing the interacted photons through a tunable filter, filtering the interacted photons into a plurality of wavelength bands. These filtered photons may be detected and analyzed to determine the presence or absence of an environmental condition. A system may comprise at least one collection lens configured to collect at least one plurality of interacted photons from at least one location and a tunable filter for filtering the interacted photons into a plurality of wavelength bands. The system may further comprise a detector configured to detect the filtered photons and generate at least one hyperspectral image representative of the location. The system may further comprise a processor for analyzing the hyperspectral data set and determining the presence or absence of an environmental condition.

### RELATED APPLICATIONS

This application claims priority under 35 U.S.C. §119(e) to pending U.S. provisional patent application No. 61/691,861, entitled “System and Method for Autonomous Shortwave Infrared Hyperspectral Imaging Detection of Ice,” filed on Aug. 22, 2012. This application is also a continuation-in-part to pending U.S. patent application Ser. No. 12/924,831, entitled “System and Method for Explosives Detection Using SWIR,” filed on Oct. 6, 2010. These applications are hereby incorporated by reference in their entireties.

### BACKGROUND

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the an entire area encompassing the sample simultaneously using an electronically tunable optical imaging filter such as an acousto-optic tunable filter (AOTF) or a liquid crystal tunable filter (LCTF). Here, the organic material in such optical filters are actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image. Spectroscopic devices operate over a range of wavelengths due to the operation ranges of the detectors or tunable filters possible. This enables analysis in the ultraviolet (UV), visible (VIS), near infrared (NW), short-wave infrared (SWIR), mid infrared (MIR) wavelengths and to some overlapping ranges. These correspond to wavelengths of about 180-380 nm (UV), about 380-700 nm (VIS), about 700-2500 nm (NIR), about 900-1700 nm (SWIR), and about 2500-25000 nm (MIR).

There exists a need for a system and method for analyzing environmental conditions. It would be beneficial if the system and method could be configured to operate in a variety of modes, including stationary and on-the-move. Such a system and method may hold potential for detecting environmental conditions such as ice and snow on roads or vehicles and alert a user to a potential hazard. Allowing a user to “see” what they normally cannot holds potential for increasing safety in a variety of industries including automotive, aviation, and preventative maintenance.

### SUMMARY

The present disclosure provides for a system and method for detecting the presence or absence of an environmental condition. For example, a system and method of the present disclosure may be configured to detect black ice ahead of an automobile driver and alert the driver via an audible and/or visual alarm so they may react appropriately. Other uses may include detecting ice on a sidewalk or parking lot and ice detection in the aviation industry. For example, airline employees responsible for de-icing of planes may be altered when residual ice is detected on a plane's exterior.

Detections may be based on reflectance/absorbance signatures and/or polarized signatures obtained through SWIR hyperspectral imaging. In one embodiment, signatures may be compared to reference signatures in a reference data base. This comparison may be accomplished using a chemometric technique. In another embodiment, a radiometric technique may be used to analyze SWIR hyperspectral images.

A method may comprise collecting a plurality of interacted photons generated by illuminating a first location. The interacted photons may be passed through a tunable filter, filtering the photons into a plurality of wavelength bands. The filtered photons may be detected to generate at least one SWIR hyperspectral image representative of the first location. The SWIR hyperspectral image may be analyzed to determine at least one of: the presence of an environmental condition and the absence of an environmental condition.

A system of the present disclosure may comprise at least one collection lens configured to collect a plurality of interacted photons from a first location. The system may further comprise a tunable filter configured to filter the interacted photons into a plurality of wavelength bands and at least one detector configured to detect the plurality of filtered photons and generate at least one SWIR hyperspectral image representative of the first location. The system may further comprise at least one processor configured to analyze the SWIR hyperspectral image to determine the presence of an environmental condition or the absence of an environmental condition.

The present disclosure also provides for a system comprising a processor and a non-transitory processor-readable storage medium in operable communication with the processor, wherein the storage medium contains one or more programming instructions that, when executed, cause the processor collect a plurality of interacted photons generated by a first location and pass the plurality of interacted photons through a tunable filter to filter the interacted photons into a plurality of wavelength bands. The system's storage medium may further comprise one or more programming instructions that, when executed, cause the processor to detect the filtered photons to generate at least one SWIR hyperspectral image representative of the first location and analyze the SWIR hyperspectral image to determine the presence of an environmental condition or the absence of an environmental condition.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

FIG. 1 is representative of a method of the present disclosure.

FIG. 2 illustrates one embodiment of a system of the present disclosure.

FIG. 3A is representative of the detection capabilities of a system and method of the present disclosure. FIG. 3A is an absorbance image at 1410 nm of a sample scene comprising a plurality of different materials representative of environmental conditions.

FIG. 3B is representative of the detection capabilities of a system and method of the present disclosure. FIG. 3B is an absorbance image at 1500 nm of a sample scene comprising a plurality of different materials representative of environmental conditions.

FIG. 3C is representative of the detection capabilities of a system and method of the present disclosure. FIG. 3C illustrates the absorbance spectra associated with the different materials of the sample scene in FIGS. 3A and 3B.

FIG. 4A is representative of the detection capabilities of a system and method of the present disclosure. FIG. 4A is an absorbance image at 1410 nm of a sample scene comprising a plurality of different materials representative of environmental conditions.

FIG. 4B is representative of the detection capabilities of a system and method of the present disclosure. FIG. 4B is an absorbance image at 1500 nm of a sample scene comprising a plurality of different materials representative of environmental conditions.

FIG. 4C is representative of the detection capabilities of a system and method of the present disclosure. FIG. 4C illustrates the absorbance spectra associated with the different materials of the sample scene in FIGS. 4A and 4B.

FIG. 5A is representative of the detection capabilities of a system and method of the present disclosure. FIG. 5A is a RGB image of a sample scene comprising a plurality of different materials representative of environmental conditions.

FIG. 5B is representative of the detection capabilities of a system and method of the present disclosure. FIG. 5B is a division image of the sample scene of FIG. 5A.

FIG. 5C is representative of the detection capabilities of a system and method of the present disclosure. FIG. 5C is a division image of the sample scene of FIG. A.

FIG. 5D is representative of the detection capabilities of a system and method of the present disclosure. FIG. 5D is a division image of the sample scene of FIG. 5A.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

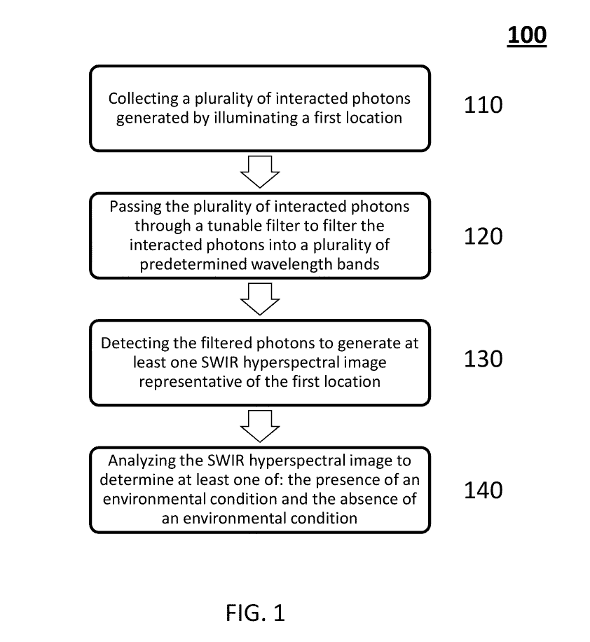

The present disclosure provides for a method for detecting environmental conditions. In one embodiment, illustrated in FIG. 1, the method 100 may comprise collecting a plurality of interacted photons generated by illuminating a first location in step 110. In one embodiment, the illuminating may be accomplished using at least one of: a passive illumination source and an active illumination source. In one embodiment, the passive illumination source may further comprise at least one of: ambient light or sunlight. In one embodiment, the active illumination source may further comprise a halogen lamp. However, the present disclosure is not limited to these illumination sources and others may be used. The plurality of interacted photons may comprise at least one of: photons absorbed by first location, photons reflected by the first location, photons scattered by the first location, and photons emitted by the first location. In one embodiment, the first location may comprise at least one of: a road, a sidewalk, a parking lot, a runway, and a vehicle, among others. In step 120 the plurality of interacted photons may be passed through a tunable filter to filter the interacted photons into a plurality of wavelength bands. In step 130 the filtered photons may be detected to generate at least one SWIR hyperspectral image representative of the first location. In step 140 the SWIR hyperspectral image may be analyzed to determine at least one of: the presence of an environmental condition and the absence of an environmental condition. In one embodiment, the environmental condition may comprise at least one of: condensation, moisture, snow, ice, and rain, among others.

In one embodiment, the method 100 may further comprise providing a reference library comprising at least one reference data set, wherein each reference data set is associated with a known environmental condition. In such an embodiment, analyzing the SWIR hyperspectral image 140 may further comprise comparing the SWIR hyperspectral image to at least one reference data set. In one embodiment, this comparison may be achieved by applying at least one of: a radiometric technique and a chemometric technique. Examples of radiometric techniques may include, but are not limited to, two wavelength division, and subtraction. Examples of chemometric techniques may include, but are not limited to, correlation analysis, principle component analysis, multivariate curve resolution, Mahalanobis distance, Euclidian distance, band target entropy, band target energy minimization, partial least squares discriminant analysis, and adaptive subspace detection. In one embodiment, these techniques may be used to generate at least one score image.

In one embodiment, the method 100 may further comprise targeting the first location using a RGB camera. In such an embodiment, the method 100 may further comprise, surveying a scene using a RGB camera. The RGB camera may generate an RGB image which can be analyzed to target a first location. In one embodiment, the first location may be targeted by detecting a morphological characteristic such as size, shape, or color of a material or object in the scene.

The present disclosure contemplates that more than one location may be analyzed and that the system and method may even be configured for continuous analysis.

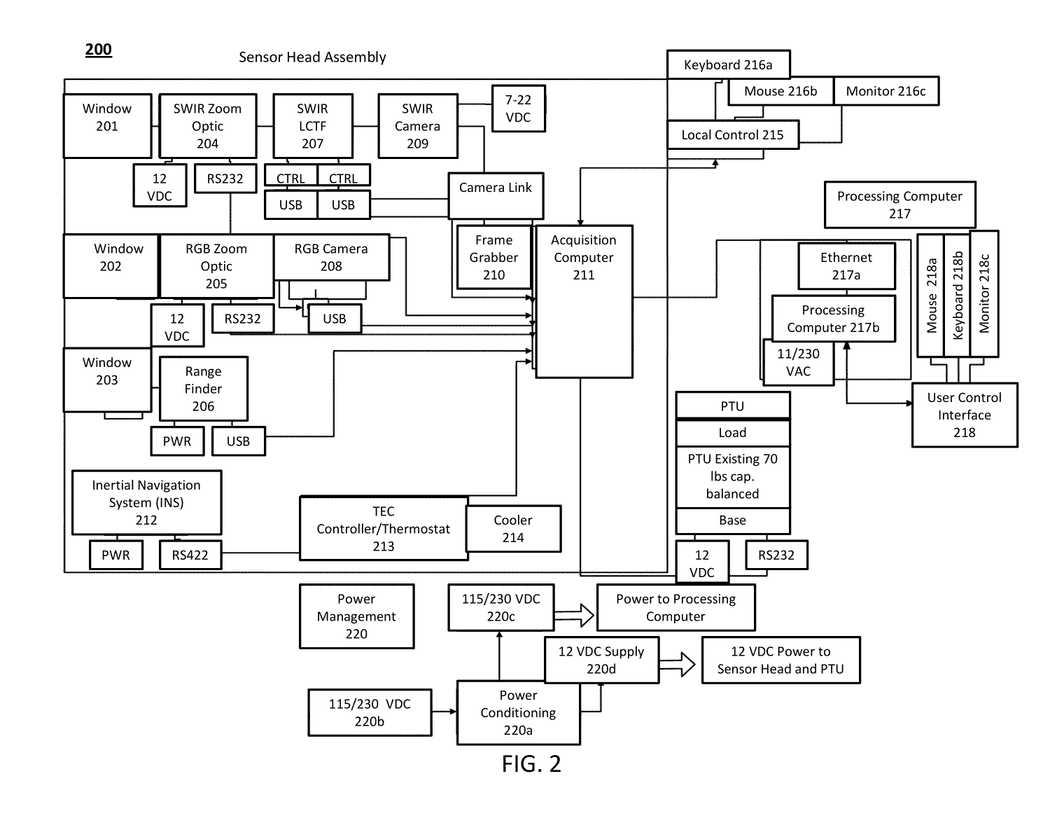

The present disclosure also provides for a system for detecting environmental conditions. In one embodiment, illustrated by FIG. 2, the system 200 may comprise one or more windows 3201, 202, and 203, which may also be referred to as collection lenses, or lenses, herein. The collection lens may be configured to collect at least one plurality of interacted photons generated from a first location. In one embodiment, the system 200 may further comprise a one or more zoom optics for focusing on one or more locations of interest. In one embodiment, the zoom optic may be capable of viewing a large area, or imaging a localized area at high magnification. In one embodiment of operation, an area would first be screened using the wide field setting on the zoom lens. Once the area is screened and potential targets are identified, confirmation of the area may be accomplished as necessary by using the narrow field setting on the zoom lens. In one embodiment, a SWIR zoom optic 204 may be operatively coupled to a tunable filter. In FIG. 2, the tunable filter is illustrated as a SWIR liquid crystal tunable filter 207. The tunable filter 207 may be configured to filter the plurality of interacted photons into a plurality of wavelength bands. In one embodiment, the tunable filter 207 may comprise at least one of: an acousto-optical tunable filters, a Lyot liquid crystal tunable filter, an Evans Split-Element liquid crystal tunable filter, a Solc liquid crystal tunable filter, a Ferroelectric liquid crystal tunable filter, and a Fabry Perot liquid crystal tunable filter.

In another embodiment, the tunable filter 207 may comprise a SWIR multi-conjugate liquid crystal tunable filter (MCF). The multi-conjugate tunable filter is a type of liquid crystal tunable filter which consists of a series of stages composed of polarizers, retarders, and liquid crystals. The multi-conjugate tunable filter is capable of providing diffraction limited spatial resolution, and a spectral resolution consistent with a single stage dispersive monochromator. The multi-conjugate tunable filter may be computer controlled, with no moving parts, and may be tuned to any wavelength in the given filter range. This results in the availability of hundreds of spectral bands. In one embodiment, the individual liquid crystal stages are tuned electronically and the final output is the convolved response of the individual stages. The multi-conjugate tunable filter holds potential for higher optical throughput, superior out-of-band rejection and faster tuning speeds.

In one embodiment, this tunable filter may comprise filter technology available from ChemImage Corporation, Pittsburgh, Pa. This technology is more fully described in the following U.S. patents and patent applications: U.S. Pat. No. 6,992,809, filed on Jan. 31, 2006, entitled “Multi-Conjugate Liquid Crystal Tunable Filter,” U.S. Pat. No. 7,362,489, filed on Apr. 22, 2008, entitled “Multi-Conjugate Liquid Crystal Tunable Filter,” Ser. No. 13/066,428, filed on Apr. 14, 2011, entitled “Short wave infrared multi-conjugate liquid crystal tunable filter.” These patents and patent applications are hereby incorporated by reference in their entireties.

In one embodiment, this multi-conjugate filter may be configured with an integrated design. Such filters hold potential for increasing image quality, reducing system size, and reducing manufacturing cost. Such a design may enable integration of a filter, a camera, an optic, a communication means, and combinations thereof into an intelligent unit. This design may also comprise a trigger system configured to increase speed and sensitivity of the system. In one embodiment, this trigger may comprise a trigger TTL. The trigger may be configured so as to communicate a signal when various components are ready for data acquisition. The trigger may be configured to communicate with system components so that data is acquired at a number of sequential wavelengths. Such a design may hold potential for reducing noise. This integration may enable communication between the elements (optics, camera, filter, etc.). This communication may be between a filter and a camera, indicating to a camera when a filter ready for data acquisition.

In one embodiment, the filter may be configured with a square aperture. This square aperture configuration holds potential for overcoming the limitations of the prior art by increasing image quality and reducing system size and manufacturing costs. Such an embodiment enables the configuration of such filters to fit almost exactly on a camera, such as a CCD. This design overcomes the limitations of the prior art by providing a much better fit between a filter and a camera. This better fit may hold potential for utilizing the full CCD area, optimizing the field of view. This configuration holds potential for an optimized design wherein every pixel may have the same characteristic and enabling a high density image.

The plurality of filtered photons may be detected by a SWIR detector 209 to generate at least one SWIR hyperspectral image. In one embodiment, the SWIR detector 209 may further comprise a focal plane array (FPA). In another embodiment, the SWIR detector 209 may further comprise at least one of: an InGaAs detector, an InSb detector, a HgCdTe detector, a CMOS detector, a CCD detector, and an ICCD detector. In one embodiment is SWIR camera 209 may be operatively coupled to a frame grabber 210 for acquiring images.

In one embodiment, the system 200 may further comprise a RGB subsystem configured for surveying a sample scene to target at least one location for interrogation using SWIR hyperspectral imaging. The RGB subsystem may comprise a collection lens to collect interacted photons from a sample scene and a RGB zoom optic 205. The RGB zoom optic 205 may be operatively coupled to a RGB detector 208. In one embodiment, the RGB detector 208 may further comprise a video capture device such as high pixel resolution, high frame rate color video camera system.

The system 200 may further comprise a range finder 206. In one embodiment, at least one of a frame grabber 210, a range finder 206, and an inertial navigation system 212 may be operatively coupled to an acquisition computer 211. In one embodiment, this acquisition computer 212 may further be coupled to at least one of: a local computer 215, a processing computer 217, and a PTU 219. In one embodiment, a local computer 215 may comprise at least one of: a keyboard 216a, a mouse 216b, and a monitor 216c to facilitate operation of the system by a user. In one embodiment, a processing computer 217 may comprise at least one of: a Ethernet configuration 217a, and a second processing computer 217b. The processing computer 217 may be operatively coupled to a user control interface system 218. The user control interface system 218 may comprise at least one of: a mouse 218a, keyboard 218b, and monitor 218c to facilitate operation by a user. The system 200 may further comprise a power management system 220 may be operatively coupled to the system 200.

The present disclosure contemplates that the system and method of the present disclosure may be configured to operate in a variety of configurations including stationary and on-the-move. Additionally, the present disclosure contemplates the system may be mounted on a vehicle for analyzing environmental conditions during operation of the vehicle by a user. The user may be altered when a potentially hazardous condition, such as black ice on a road, is detected.

### EXAMPLES

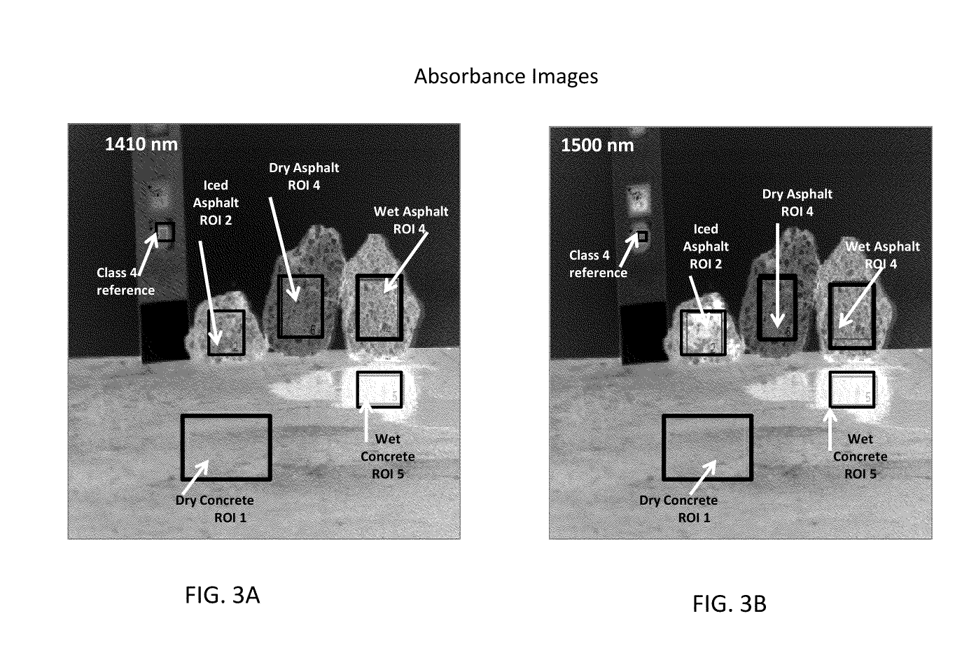

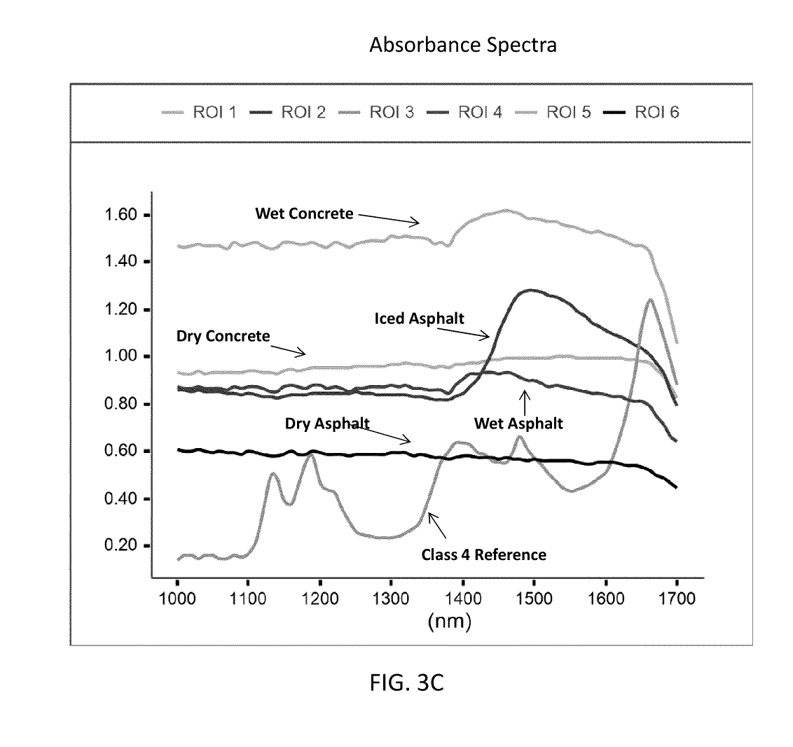

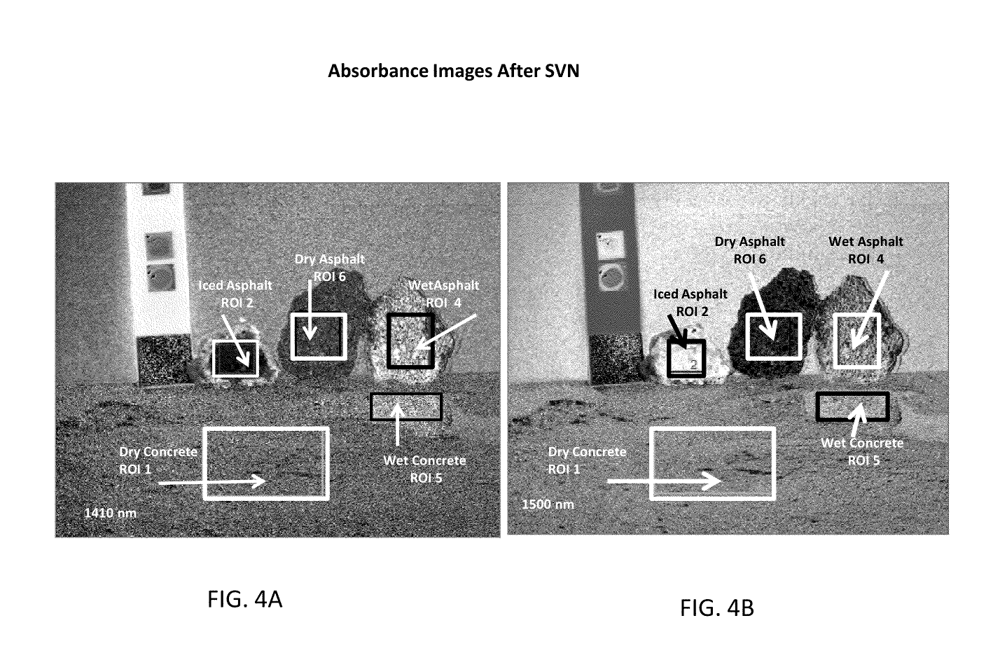

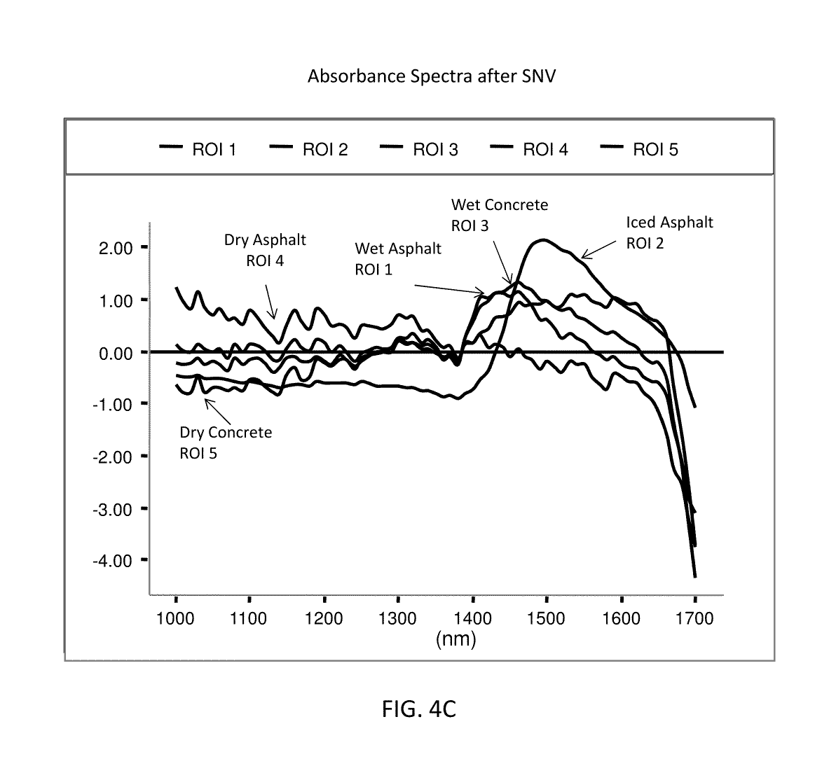

FIGS. 3A-4C are provided to illustrate the detection capabilities of a system and method of the present disclosure. Data was generated using a SWIR hyperspectral imaging system such as that represented in FIG. 2, at a standoff distance of approximately 7 meters. Two ruggedized FNN lights were used as illumination sources. A free spectral range of 1000 nm-1700 nm was used, with a 10 nm step. Processing included dark, 99% divide, −log, and SNV. Data was generated using RTTK software and analyzed using ChemImage Xpert® software, both available from ChemImage Corporation, Pittsburgh, Pa. FIGS. 3A and 3B are absorbance images of a sample scene comprising a plurality of different materials representative of environmental conditions. FIG. 3A is an absorbance image at 1410 nm and FIG. 3B is an absorbance image at 1500 nm. Regions of interest (ROI) are selected in each image corresponding to different materials. Spectra may be extracted from the image at these regions of interest and analyzed, as illustrated in FIG. 3C. FIG. 3C illustrates that different materials associated with environmental conditions (such as dry or iced concrete) will have different associated spectra.

Similar detection capabilities are illustrated in FIGS. 4A-4C. FIG. 4A is an absorbance image at 1410 nm and FIG. 4B is an absorbance image at 1500 nm. Spectra may be extracted as illustrated in FIG. 4C. FIG. 4C illustrates that different materials associated with environmental conditions will have different associated spectra.

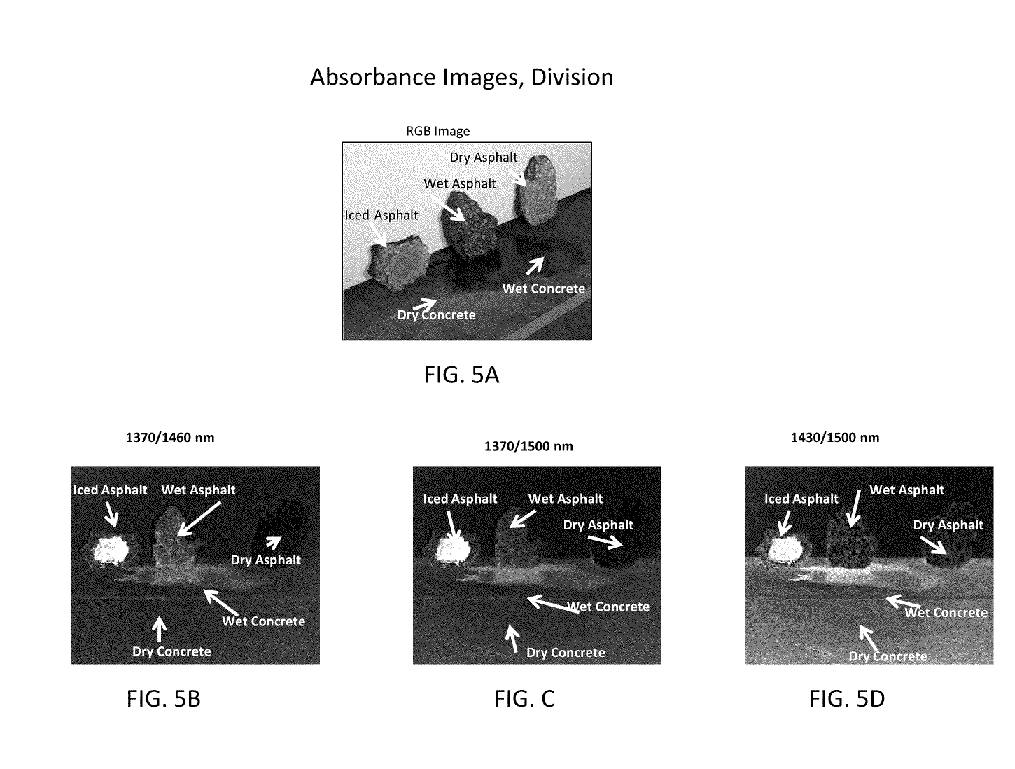

FIGS. 5A-5D are also representative of the detection capabilities of a system and method of the present disclosure. These figures illustrate the capabilities of applying a radiometric technique to data, such as wavelength division. FIG. 5A is a RGB image of a sample scene comprising a plurality of different materials representative of environmental conditions. The RGB image can be used to locate areas of interest and as a reference for orientating the location of objects or materials in a scene. FIG. 5B is a division image of the sample scene of FIG. 5A, using the wavelengths of 1370 nm and 1460 nm. Division images may also be referred to as score images. As illustrated in FIG. 5A, iced asphalt, wet asphalt, and wet concrete are visible after the division. FIG. 5C is a division image of the sample scene of FIG. 5A using the wavelengths of 1370 nm and 1500 nm. As illustrated in FIG. 5B, iced asphalt, wet asphalt, and wet concrete are visible after the division. FIG. 5D is a division image of the sample scene of FIG. 5A using the wavelengths of 1430 nm and 1500 nm. As illustrated in FIG. 5D, iced asphalt, wet asphalt, and wet concrete are visible after the division.

The above description is not intended and should not be construed to be limited to the examples given. While the disclosure has been described in detail in reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A system comprising:
at least one collection lens configured to collect a plurality of interacted photons from a first location;
at least one tunable filter configured to filter the plurality of interacted photons into a plurality of wavelength bands;
at least one detector configured to detect the plurality of filtered photons and generate at least one SWIR hyperspectral image representative of the first location; and
at least one processor configured to analyze the SWIR hyperspectral image to determine at least one of: the presence of an environmental condition and the absence of an environmental condition.

2. The system of claim 1 wherein the environmental condition further comprises at least one of: condensation, moisture, snow, ice, and rain.

3. The system of claim 1 further comprising at least one zoom optic configured to target the first location.

4. The system of claim 1 further comprising at least one RGB camera configured to generate at least one RGB image of the first location.

5. The system of claim 1 further comprising a reference library comprising at least one reference data set, where in each reference data set is associated with a known environmental condition.

6. The system of claim 1 wherein the tunable filter further comprises at least one of: a multi-conjugate tunable filter, a liquid crystal tunable filter, an acousto-optical tunable filters, a Lyot liquid crystal tunable filter, an Evans Split-Element liquid crystal tunable filter, a Solc liquid crystal tunable filter, a Ferroelectric liquid crystal tunable filter, and a Fabry Perot liquid crystal tunable filter.

7. The system of claim 1 wherein the detector further comprises a focal plane array.

8. The system of claim 1 wherein the detector further comprises at least one of: an InSb detector, a HgCdTe detector, a CMOS detector, a CCD detector, an ICCD detector, and an InGaAs detector.

9. The system of claim 1 further comprising at least one of: an active illumination source and a passive illumination source.

10. A method comprising:
collecting a plurality of interacted photons generated by illuminating a first location;
passing the plurality of interacted photons through a tunable filter to filter the interacted photons into a plurality of wavelength bands;
detecting the filtered photons to generate at least one SWIR hyperspectral image representative of the first location; and
analyzing the SWIR hyperspectral image to determine at least one of: the presence of an environmental condition and the absence of an environmental condition.

11. The method of claim 10 wherein the illuminating further comprises at using at least one of: active illumination and passive illumination.

12. The method of claim 10 wherein the environmental condition further comprises at least one of: condensation, moisture, snow, ice, and rain.

13. The method of claim 12 further comprising providing a reference library comprising at least one reference data set, wherein each reference data set is associated with a known environmental condition.

14. The method of claim 13 wherein analyzing further comprises comparing the SWIR hyperspectral image to at least one reference data set.

15. The method of claim 14 wherein the comparison is further achieved by applying at least one of: a radiometric technique and a chemometric technique.

16. The method of claim 15 wherein the chemometric technique further comprises at least one of: correlation analysis, principle component analysis, multivariate curve resolution, Mahalanobis distance, Euclidian distance, band target entropy, band target energy minimization, partial least squares discriminant analysis, and adaptive subspace detection.

17. The method of claim 14 wherein the radiometric technique further comprises at least one of: two wavelength division and subtraction.

18. The method of claim 10 further comprising targeting the first location by surveying a scene using a RGB camera.

19. The method of claim 10 wherein the first location further comprises at least a portion of at least one of: a road, a sidewalk, a parking lot, a runway, and a vehicle.

20. A system comprising:
a processor; and
a non-transitory processor-readable storage medium in operable communication with the processor, wherein the storage medium contains one or more programming instructions that, when executed, cause the processor to perform the following:
collect a plurality of interacted photons generated by a first location;
pass the plurality of interacted photons through a tunable filter to thereby filter the interacted photons into a plurality of wavelength bands;
detect the filtered photons to generate at least one SWIR hyperspectral image representative of the first location; and
analyze the SWIR hyperspectral image to determine at least one of: the presence of an environmental condition and the absence of an environmental condition.

21. The system of claim 20 wherein the storage medium further contains one or more programming instructions that, when executed to analyze the SWIR hyperspectral image, further causes the processor to: compare the SWIR hyperspectral image to at least one reference data set, wherein each reference data set is associated with a known environmental condition.

22. The system of claim 20 wherein the storage medium further contains one or more programming instructions that, when executed to compare the SWIR hyperspectral image to at least one reference data set, further causes the processor to apply at least one of: a radiometric technique and a chemometric technique.
